(19) United States
(12) Patent Application Publication
(10) Pub. No.: US 2025/0384455 A1
(43) Pub. Date: Dec. 18, 2025

(54) Statistical Method for Determining and Removing Noise from Data Sets

(71) Applicant: Denver Health and Hospital Authority, Denver, CO (US)

(72) Inventors: Joshua C. Black, Lakeview, CO (US); Annika Czizik, Denver, CO (US); Karilynn Rockhill, Golden, CO (US); Nicole Schow, Denver, CO (US)

(73) Assignee: Denver Health and Hospital Authority, Denver, CO (US)

(21) Appl. No.: 18/744,806

(22) Filed: Jun. 17, 2024

(51) Int. Cl. G06Q 30/0203

(52) U.S. Cl. CPC G06Q 30/0203

(57) ABSTRACT

The invention outlined here is an innovative approach to increasing the accuracy of survey responses by combining novel classification of inaccurate survey responses as noise with state-of-the-art statistical techniques. This invention innovatively combines 1) a novel method to quantify inaccurate survey responses, with 2) statistical distribution assessment of variability to quantify bounds of classification, and 3) statistical classification of responses into at least 3 categories of inaccuracy. This invention is implemented by a computer and will generate estimates of variability, which are subsequently utilized in classification. These estimates can be effectively used to classify field responses as either signal, noise, or indeterminate and be used to probabilistically adjust numerical calculations of field response in surveys.

### BACKGROUND

### Field of the Invention

The present invention relates generally to computer-implemented statistical methods. More specifically, the present invention relates to computer-implemented methods of removing non-random noise from a data set of survey answers given by survey participants and quantify statistically accurate estimates of drug use and related behaviors.

### Description of the Related Art

The field of statistical methods and survey-based data analysis has witnessed significant developments. Previous approaches to handle noise and enhance the accuracy of statistical estimates in survey data have often relied on traditional statistical techniques such as outlier removal, smoothing, careless response removal. Online surveys are a recently developed and widely adopted method for collecting data, which has traditionally been conducted as telephone cold calling, mail-based surveys, and in person interviews. Existing methodologies for estimating drug use and related behaviors based on survey data may encounter limitations in terms of accuracy and reliability.

Current art in quantifying inaccurate responses in online survey data primarily involves classifying responding patterns. Literature in inattentive response identification relies on individuals answering questions in a pattern that is suggestive of inaccuracies. Individuals enter data into a computer, which is then analyzed using simple statistics such as via addition, standard deviations, and correlation calculations. Attention grabbing items have been created that can classify inattentive response patterns.

A significant evolution in statistical techniques recently involves the emergence of second-generation p-values. The traditional p-value in statistics is a binary classification method for identifying when a mathematical number is more unusual than random chance would dictate. The second-generation p-value is an advanced statistical measure able to provide more rigorous, reproducible, & transparent methods for classification. The second-generation p-values offer a deeper understanding of statistical significance, considering factors like effect size and variability, and can generate three classification categories.

### SUMMARY

In accordance with the embodiments here, methods for computer-implemented methods of removing non-random noise from a data set of survey answers given by survey participants and quantify statistically accurate estimates of use and related behaviors. The method generally comprises the following eight steps: i) designing a survey questionnaire that includes at least one non-existent product presented alongside at least one real product, ii) collecting field responses to the survey questionnaire related to both the at least one non-existent product and the at least one real product, iii) creating a second-generation interval null hypothesis from the field responses related to the at least one non-existent product, iv) generating confidence intervals for the at least one real product from the field responses, v) calculating a second-generation p-value based on the overlap of the confidence intervals and the second-generation interval null hypothesis, vi) utilizing the second-generation p-value to determine if the field responses related to the at least one real product is noise, signal, or indeterminate, vii) categorizing the field responses of the at least one real product that is determined to be signal or noise to either conclude the at least one real product is or is not used in a widespread manner within the survey's inference population, wherein the survey's inference population is a set of items, events, or people from which the survey sample is selected, and viii) conducting further computer simulation using the at least one real product and the at least one non-existent product to more accurately quantify statistical estimates of use and related behaviors about the survey questionnaire's inference population.

### BRIEF DESCRIPTION OF THE DRAWINGS

FIG. 1 is an overview of the method.

### DETAILED DESCRIPTION OF EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention.

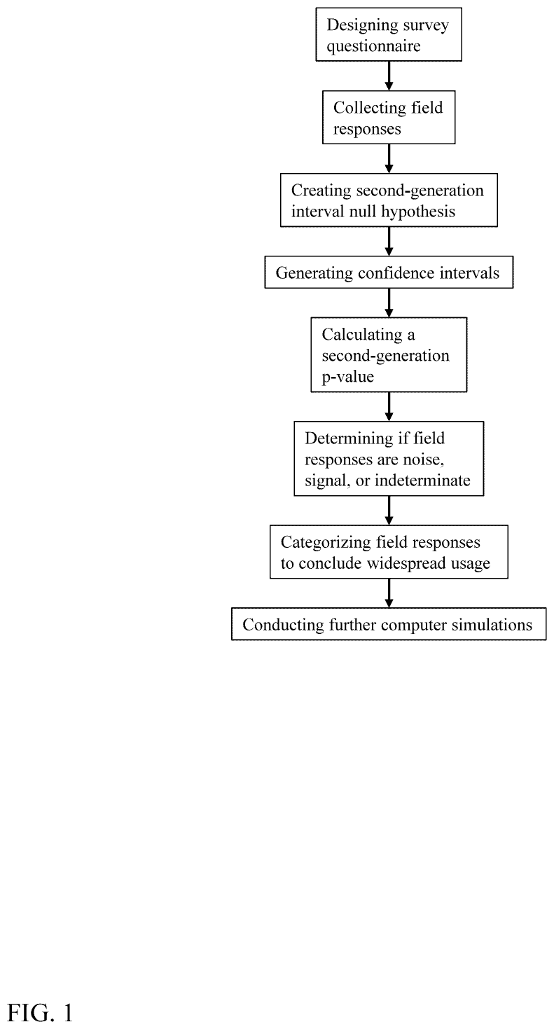

In an illustrative embodiment of the invention, the method may generally comprise eight consecutive steps, including i) designing a survey questionnaire that includes at least one non-existent product presented alongside at least one real product, ii) collecting field responses to the survey questionnaire related to both the at least one non-existent product and the at least one real product, iii) creating a second-generation interval null hypothesis from the field responses related to the at least one non-existent product, iv) generating confidence intervals for the at least one real product from the field responses, v) calculating a second-generation p-value based on the overlap of the confidence intervals and the second-generation interval null hypothesis, vi) utilizing the second-generation p-value to determine if the field responses related to the at least one real product is noise, signal, or indeterminate, vii) categorizing the field responses of the at least one real product that is determined to be signal or noise to either conclude the at least one real product is or is not used in a widespread manner within the survey's inference population, wherein the survey's inference population is a set of items, events, or people from which the survey sample is selected, and viii) conducting further computer simulation using the at least one real product and the at least one non-existent product to more accurately quantify statistical estimates of use and related behaviors about the survey questionnaire's inference population. FIG. 1 outlines an example of the process to remove non-random noise from a data set of survey answers given by survey participants and quantify statistically accurate estimates of use and related behaviors.

In some embodiments, the survey questionnaire includes elements of written questions or images, or possibly both. Frequently, the non-existent products and the real products in the questionnaire are drug products. When the non-existent products are drug products, they have names or mock-up images that evoke the idea of real drug products.

In other embodiments, the method includes the set of creating a distribution from the field responses such that the distribution describes the at least one non-existent product.

In additional embodiments, the second-generation interval null hypothesis includes an upper bound and a lower bound created from the distribution. Frequently, the upper bound is created using empirical bootstrap, Poisson, Gaussian, or Maximal methods. When using the empirical bootstrap method, a computer is used to generate multiple fake distributions via bootstrap with replacement, calculating a mean number of fake responses for each bootstrap sample, calculating the mean and standard deviation of the mean number of fake responses, and setting the upper bound of the second-generation interval null hypothesis as mean plus one standard deviation. When using the Poisson method, the mean, variance, and standard deviation of the field responses related to the non-existent products using Poisson distribution assumptions are calculated and then the upper bound is set as the observed mean plus one standard deviation. When using the Gaussian method, the mean, variance, and standard deviation of the field responses related to the non-existent products using Gaussian distribution assumptions are calculated and then the upper bound is set as the observed mean plus one standard deviation. When using the Maximal method, the upper bound is set as the maximum observed number of non-existent products endorsed by a survey participant.

When setting the lower bound, the minimal or zero method is used. When using the minimal method, the lower bound is set as the minimum number of observed non-existent products endorsed by a survey participant. When using the zero method, the lower bound is set to zero.

In some embodiments, the confidence intervals for the real products are established by using empirical bootstrap, Poisson, or Gaussian methods.

In some embodiments, the field responses are classified using the numerical overlap of the interval null hypothesis derived from the at least one fake product with the confidence interval of the at least one real product. Numerical overlap is defined as three categories. First, lack of overlap is where the upper limit of the interval null hypothesis is smaller than the lower limit of the confidence interval. Second, indeterminate overlap is when the upper limit of the interval null hypothesis is larger than the lower limit of the confidence interval but smaller than the upper limit of the confidence interval. Third, complete overlap is where the upper limit of the interval null hypothesis is larger than the upper limit of the confidence interval.

In further embodiments, the numerical overlap is used in a computer simulation to determine whether field responses should be probabilistically removed from further numerical calculations involving those field responses.

The invention outlined here is an innovative approach to increasing the accuracy of survey responses by combining novel classification of inaccurate survey responses as noise with state-of-the-art statistical techniques. This invention innovatively combines 1) a novel method to quantify inaccurate survey responses, with 2) statistical distribution assessment of variability to quantify bounds of classification, and 3) statistical classification of responses into at least 3 categories of inaccuracy. This invention is implemented by a computer and will generate estimates of variability, which are subsequently utilized in classification. These estimates can be effectively used to classify field responses as either signal, noise, or indeterminate. This invention is distinguished from existing art.

All embodiments of this invention are only realistically feasible through the use of a computer, and some embodiments are impossible without the aid of a computer. First, construction of statistical distributions is best done using hundreds of non-existent products, and questions are each asked of at least thousands, up to hundreds of thousands, of survey respondents, leading to potentially millions of assessments. Even using only a single non-existent product will require assessment of potentially hundreds of thousands of field responses. While technically possible to do without a computer, it is not feasible to validly conduct statistical distributions from these many non-existent products without the aid of a computer. Second, the creation of bootstrap estimates is not possible without the aid of a computer. In bootstrap analysis, samples are recreated hundreds or thousands of times. The recreation requires a probabilistic selection of individuals to be resampled, and probabilistic selection requires a computer to create the random numbers. Third, some embodiments of the present invention apply the determined classification to all real products. Similarly, many embodiments will include hundreds of real products, making assessments of the numerical overlap for so many products not feasible without the aid of a computer. Fourth, the simulation to more accurately quantify field responses is not possible without a similar probabilistic assignment based on the 2nd generation p-value as implemented by computer-generated random numbers.

What is claimed is:

1. A method comprising:
designing a survey questionnaire that includes at least one non-existent product presented alongside at least one real product;
collecting field responses to the survey questionnaire related to both the at least one non-existent product and the at least one real product;
creating a second-generation interval null hypothesis from the field responses related to the at least one non-existent product;
generating confidence intervals for the at least one real product from the field responses;
calculating a second-generation p-value based on the overlap of the confidence intervals and the second-generation interval null hypothesis;
utilizing the second-generation p-value to determine if the field responses related to the at least one real product is noise, signal, or indeterminate;
categorizing the field responses of the at least one real product that is determined to be signal or noise to either conclude the at least one real product is or is not used in a widespread manner within the survey's inference population, wherein the survey's inference population is a set of items, events, or people from which the survey sample is selected; and
conducting further computer simulation using the at least one real product and the at least one non-existent product to more accurately quantify statistical estimates of use and related behaviours about the survey questionnaire's inference population.

2. The method of claim 1, wherein the survey questionnaire includes elements selected from the group consisting of written questions and images.

3. The method of claim 1, wherein the at least one non-existent product is a non-existent drug product and the at least one real product is a drug product.

4. The method of claim 1, further comprising creating a distribution from the field responses such that the distribution describes the at least one non-existent product.

5. The method of claim 4, wherein the second-generation interval null hypothesis includes an upper bound and a lower bound created from the distribution.

6. The method of claim 5, wherein the upper bound is created using a method selected from the group consisting of empirical bootstrap, Poisson, Gaussian, and Maximal methods.

7. The method of claim 6, wherein the empirical bootstrap method includes the steps of using a computer to generate multiple fake distributions via bootstrap with replacement, calculating a mean number of fake responses for each bootstrap sample, calculating the mean and standard deviation of the mean number of fake responses, and setting the upper bound of the second-generation interval null hypothesis as mean plus one standard deviation.

8. The method of claim 6, wherein the Poisson method includes the steps of calculating the mean, variance, and standard deviation of the field responses related to the non-existent products using Poisson distribution assumptions and setting the upper bound as the observed mean plus one standard deviation.

9. The method of claim 6, wherein the Gaussian method includes the steps of calculating the mean, variance, and standard deviation of the field responses related to the non-existent products using Gaussian assumptions and setting the upper bound as the observed mean plus one standard deviation.

10. The method of claim 6, wherein the Maximal method includes the step of setting the upper bound as the maximum observed number of non-existent products endorsed by a survey participant.

11. The method of claim 5, wherein the lower bound is created using a method selected from the group consisting of minimal method and zero method.

12. The method of claim 11, wherein the minimal method includes the step of setting the lower bound as the minimum number of observed non-existent products endorsed by a survey participant.

13. The method of claim 11, wherein the zero method includes the step of setting the lower bound to zero.

14. The method of claim 1, wherein the confidence intervals for the at least one real product are established via a method selected from the group consisting of empirical bootstrap, Poisson, and Gaussian.

15. The method of claim 1, wherein the field responses are classified using a numerical overlap of the interval null hypothesis derived from the at least one fake product with the confidence interval of the at least one real product.

16. The method of claim 1, wherein the numerical overlap is used in a computer simulation to determine whether field responses of the at least one real product should be probabilistically removed from further numerical calculations involving those field responses.
